(19) United States
(12) Patent Application Publication
(10) Pub. No.: US 2016/0353708 A1
(43) Pub. Date: Dec. 8, 2016

(54) In-Vehicle Riding and Viewing Platform for Dogs

(71) Applicant: Michael Robert Gonzalez, Laguna Beach, CA (US)

(72) Inventor: Michael Robert Gonzalez, Laguna Beach, CA (US)

(21) Appl. No.: 15/215,489

(22) Filed: Jul. 20, 2016

Related U.S. Application Data
(63) Continuation-in-part of application No. 14/289,659, filed on May 29, 2014.

(51) Int. Cl. A01K 1/02

(52) U.S. Cl. CPC A01K 1/0272

(57) ABSTRACT

An assembly of shaped components of firm but compressible materials that create an elevated platform within the passenger areas of a vehicle that provides a dog or dogs with enhanced comfort, safety and external views through the vehicle's windows from the down resting position. The assembly generally includes a horizontally placed component that delivers a level elevated surface and two or more vertical components placed in the leg-room area that support the horizontal component. The components are attached and detached in various combinations for quick placement, removal, storage and portability.

### CROSS-REFERENCE TO RELATED APPLICATIONS

This application is a Continuation in Part for application Ser. No. 14/289,659 and is related to provisional patent application U.S. 61/956,082.

### BACKGROUND-FIELD OF INVENTION

This invention relates to pet accessories, specifically to such accessories that are used to provide containment, comfort or safety of pets while being transported in vehicles.

### BACKGROUND-DESCRIPTION OF PRIOR ART

Car seats are made for humans to sit upon. Dogs riding in vehicles are faced with two equally bad choices. (a) They may sit or stand upright-positions that they cannot maintain for very long and in which they are easily tossed around or into the legroom area by the frequent starting, stopping, turning and swerving of the vehicle or (b) they may lie prone on the seat where they easily develop motion sickness brought on by the disconnect between the motion sensed by the body and their fixed view of the inner confines of the vehicle. All of this causes anxiety and stress creating an unhappy and often sick pet.

Others have tried to address various parts of this problem in a number of ways. A review of related products on the market at time of this application shows the following prior art categories:
1. Soft material booster seats that typically have three raised sides and sit atop the vehicle seat's horizontal surface and are secured using the vehicles seat belt mechanisms. They provide a slightly elevated pocket for smaller dogs but cannot be made large enough for medium or larger dogs. They also move unpredictably under influence of vehicle motion and therefore do not feel stable to the dog.
2. Pads that stretch over the full width of the back seat. These create a narrow resting surface on which larger dogs must lie facing the side of the vehicle. They tend to move in reaction to but out of synchronization with vehicle motion and do not solve the problem of the dog being thrown into the foot rest area.
3. Fillers that address the problem of the dog being thrown into the foot rest area but do nothing to provide elevation, view and comfort.

Several patents have been granted that fall in the field of invention of this application.
4. U.S. Pat. No. 7,886,694 to Jakubowski, et al. (2011) for a “Pet Booster Seat” shows a concept and design typical of market product category #1 above. This design is clearly not scalable to serve medium and larger dogs. It also requires connection to the vehicle through the seat belt which does not prevent it from moving independently in reaction to the motion of the vehicle. Also, unless the dog is tightly tethered to the booster seat, it does not prevent ejection into the leg room area.
5. U.S. Pat. No. 6,588,365 to Best Wright (2003) for a “Pet booster seat system and method” is similarly suitable for small pets only as the entire apparatus must fit on top of and be tethered to a single seat surface. It also does not address the problem of independent motion induced upon the apparatus by the motion of the vehicle nor the potential for ejection into the leg room areas.
6. U.S. Pat. No. 7,478,858 to Brun (2006) for a Pet Traveler Assembly is similar in its use of some materials and in its intended application to pets travelling in vehicles. However, it is clearly intended as a softer and more comfortable and convenient replacement for hard material cages and barriers typically used in SUV cargo areas to transport dogs. Further it relies upon the flat surface found in the cargo compartment to be utilized. Brun states (lines 32 through 35) that the assembly “can be structured to be fitted to and utilized in other interior regions of a vehicle, for example, a rear passenger seating region” but such an application of the Brun apparatus would result only in a soft containment of the dog resting on the passenger seat in the orientation that the drawings illustrates for use in the cargo area. In no way can it be understood from the claims of U.S. Pat. No. 7,478,858 how the apparatus could, in any embodiment, create a stable, elevated and freely accessible riding and viewing platform for a dog in the passenger areas of a vehicle as does the assembly of this application. It should be mentioned that there has been no discoverable practice of the Brun patent in a manner that suggests prior art. Also the Brun patent appears to have been abandoned.
   None of the products discovered through market search and none of the relevant designs or methods discovered through a US patent search appear to provide the functionality of the apparatus in the application, that is, the creation of an elevated riding platform in the passenger area of vehicles accommodating all sizes of dogs that is stable and comfortable and that moves in lock step with vehicle motion. No prior art I have found provides the benefit of a safe and anxiety-free vehicle experience for dogs with external viewing from the down resting position.

### SUMMARY

The in-vehicle riding and viewing platform is a plurality of components made of soft and compressible yet structurally firm materials of predetermined sizes, contours and shapes that can be assembled into a stable, horizontally level, elevated platform in the human passenger areas of most vehicles without any direct attachment to any part of the vehicle. The platform enables one or more dogs to have an enhanced in-vehicle riding and visual experience from their natural down resting position. The invention also provides for easy portability, compact storage and easy placement in and removal from the vehicle.

### Objects and Advantages

Objects and advantages of the present invention are:
(a) The invention is comprised of a plurality of components of predetermined size, shape and material composition, assembled together and placed to volumetrically fill portions of a vehicle's passenger space in such a way that an elevated riding platform is created. Because vehicle passenger areas are of varying sizes with irregularly shaped and sloped seats, the components are sized and shaped to achieve a level and stable surface for dogs in the passenger seating areas of a high percentage of cars, SUVs and Trucks.
(b) The assembly is assisted by appropriately placed strips of Velcro or similar fastening artifacts. The main horizontal component is firm yet sufficiently compressible in the vertical direction to provide comfort to the dog rider.
(c) The main horizontal is much less compressible in the horizontal direction and this enables the adjustability of front seat position to secure or trap the assembly between two fixed surfaces of the vehicle. No direct attachment to any part of the vehicle is required. The platform components are user-assembled and can be installed and un-installed in seconds.
(d) The platforms thus created move in lock step with vehicle motion, front-to-rear and side-to-side. A dog immediately recognizes the stability of the surface while in motion, unlike other booster devices that can move independently in reaction to vehicle motion.
(e) After stepping up onto the surface of the platforms so created, the dog passenger can assume a natural down resting position and still enjoy the same visual experience as human passengers through any of the vehicle windows while feeling comfortable and secure under most normal driving condition.
(f) The invention thus accomplishes the elimination of the potential for being thrown into the leg room area and provides containment within the existing surfaces of the vehicle interior and this in turn provides a higher degree of safety for a dog travelling in a vehicle that is stopping and starting, turning and swerving. Also, widely used safety tether straps connected to the seat belt receptacle become more acceptable to the dog due to its more comfortable and engaged resting position on the elevated platform.
(g) Each component piece may be encased in a variety of fabrics that contributes to its rigidity, comfort and appearance. Zippers provide means to replace fabric encasements, a top surface fabric attached by VELCRO can be easily removed for cleaning surfaces.
(h) The assembly components are designed to be fit together very easily and quickly in a compact form for storage and portability. This enables the dog owner to easily install, remove, carry or store the assembly.

### DRAWING FIGURES

FIG. 1 is a view of the preferred embodiment collapsed into its most compact form for storage and portability.

FIG. 2 is in an exploded view that shows each component and some component detail.

FIG. 3 is a view of the core construction of the main platform component.

FIG. 4 is a view of the assembly in the preferred embodiment installed to one side of a passenger seat of a vehicle.

FIG. 5 is a view of the assembly in the preferred embodiment installed at the center of a rear passenger seat of a vehicle.

FIG. 6 is a view of the assembly placed in a cutout view of a vehicle to which it is applied.

FIG. 7 is a top view of a vehicle rear seat showing an assembly plus an extender.

### REFERENCE NUMERALS IN DRAWINGS

1. The main platform component
2. Leg area support components.
3. Convenient carry handle.
4. Cutout that contains support components (2) for storage and portability
5. Fabric covers with zippers.
6. VELCRO hook strip
7. VELCRO loop strips
8. Flexible pull-apart leg area component connector.
9. Pull-away fabric top with VELCRO hook strip border
10. Inner core assembly
11. Compensating mitered corners
12. Top foam core
13. Bottom foam core with compensating contours
14. Compensating contour
15. Stiffener pegboard
16. Top view of typical vehicle rear passenger seat
17. Extender component

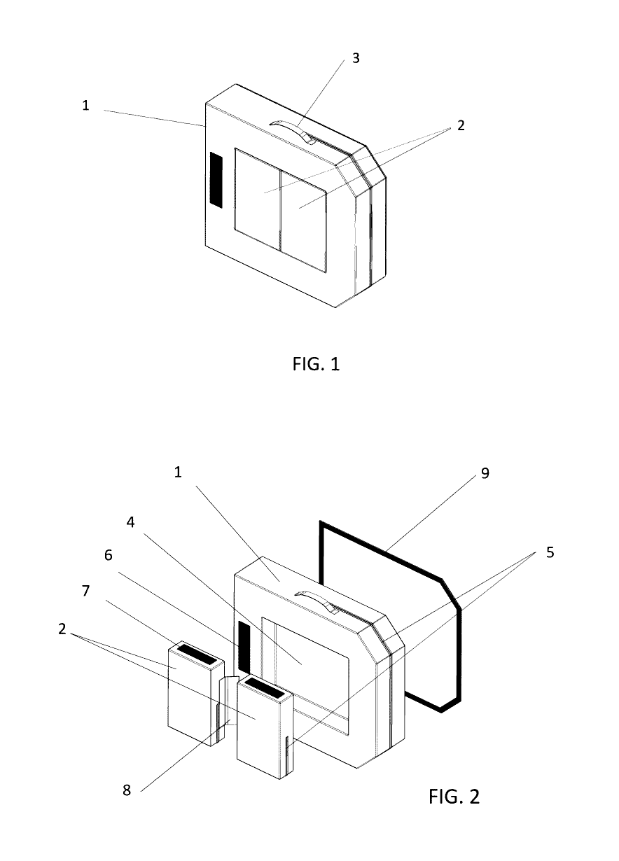

### Description—FIGS. 1,2,3,4,5,6,7—Preferred Embodiment

A preferred embodiment of the in-vehicle riding and viewing assembly is illustrated in FIGS. 1, 2, 3, 4, 5, 6 and 7.

FIG. 1 shows the complete assembly in compact form for storage, handling and portability. A main component (1) of the assembly has a compartment that may contain two supporting components (2). The combined assembly is provided with a convenient carry handle (3).

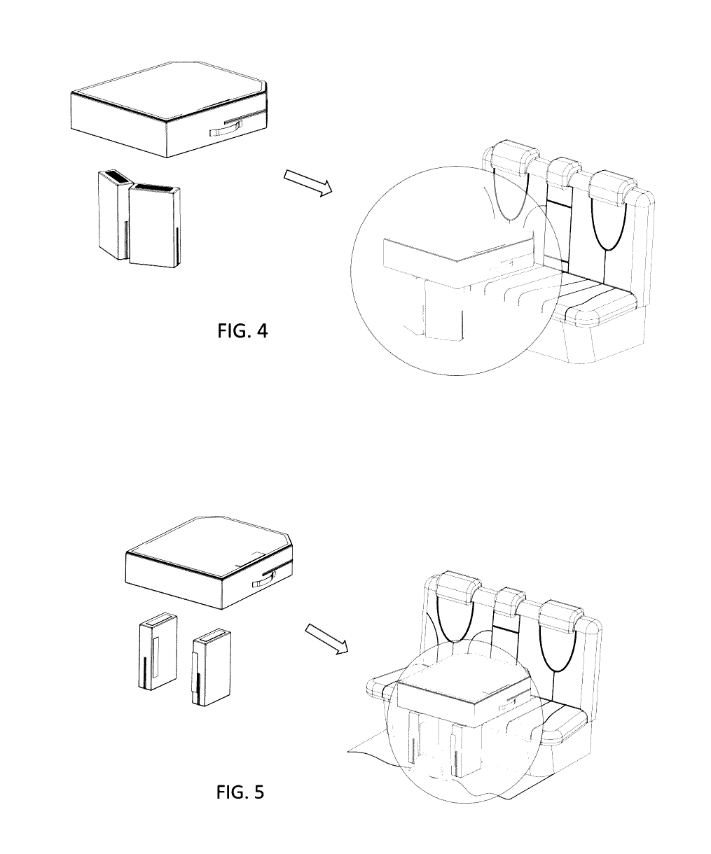

FIG. 2 shows a detailed view of the assembly components in an un-packed state. Two supporting components (2) are removed from a compartment (4) in the main platform component (1). The compartment (2) is substantially the same size as two support components (2) such that they can be pressed into and pulled out of the compartment where they are securely stored and ported when the assembly is not in use without the need for any fastening mechanism. All components are covered in a nylon or other fabric with zippers (5) for easy removal and replacement. The supporting components (2) have attaching strips (7) of VELCRO—loop or equivalent along the top surface when oriented vertically. The main platform component (1) has an attaching strip (6) of VELCRO—hook or equivalent permanently attached to one side, a position that enables it to connect to the attaching strips on the supporting components (2) when all components are placed in their installed positions as shown in FIGS. 4, 5, 6. The two supporting components are attached to one another by a flexible strap (8) sewn permanently to one and attached with VELCRO or equivalent to the other. This enables the vertical support components (2) to be placed in whatever orientation provides the strongest support for the main horizontal platform component in a variety of vehicles and in-vehicle locations. Further, the vertical support components (2) may be separated and placed to avoid an obstruction in the vehicle leg room area such as rear transmission hump when the assembly is placed in the center of the rear passenger bench as shown in FIG. 5. Also shown in FIG. 2 is a removable fabric topping (9) that is added for comfort, easy cleaning and to match the trim aesthetics of the vehicle.

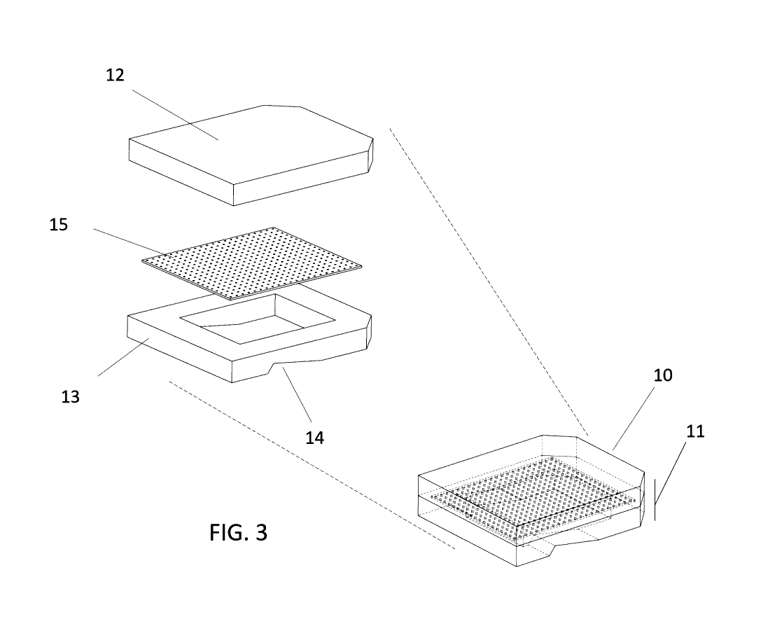

Turning now to FIG. 3 showing the make-up of the inner core (10) of the main component (1): The inner core consists of three layers glued together. The assembled core has two mitered corners (11) on the side of the component that will rest against the back riser of a typical passenger seat enabling the assembly to fit more or less snugly. Also shown in FIG. 3 are individual layers of the inner core. The top layer (12) consists of a firm but compressible polyurethane foam or equivalent to provide both comfort and stability. The bottom layer (13) is also made of firm compressible material but with a through hole cut to precisely the size of the two support components (2) set side to side. The underside of the bottom layer is shaped (14) in roughly the complement of the slope and contours found on the seat surface of a typical passenger seat. The purpose of said shaping is to insure that the top of the main horizontal platform component presents a substantially level surface to the dog rider by compensating for the contours and slopes of typical vehicle passenger seats. Finally, a sheet of non-compressible material (15) such as a pegboard is placed between the top and bottom layers to prevent collapse of the top layer (12) under load into the through-hole in the bottom layer (13), to provide stiffness so that the assembly can be secured by the adjustability of the front passenger seat and to insure overall stability and strength of the assembly.

Now turning to FIGS. 4, 5 and 6 showing the installed assembly: FIG. 4 shows the assembly components in an orientation as typically installed and as placed on a rear seat of a vehicle. The elevation above the passenger seat sitting surface provided by the assembly is 4 to 8 inches, a range that will enable most dogs using the assembly in a down position to gain a view out of any side or forward window with a simple rise of the head. The length of the horizontal platform component measured in the direction of vehicle travel is such that the platform substantially covers the distance from the back side of the front seat to the vertical surface of the riser portion of the rear seat, thereby maximizing the usable horizontal resting surface. The width can be varied to accommodate different dog breeds and sizes.

FIG. 5 shows an alternate configuration with the leg area support components separated to accommodate an obstruction in the leg room area. Furthermore, it is easy to see that the support components could be angled or placed in a wide variety of positions depending on the space available in the leg room area with the end result of a stable and level riding platform assembly across a variety of vehicle interior sizes.

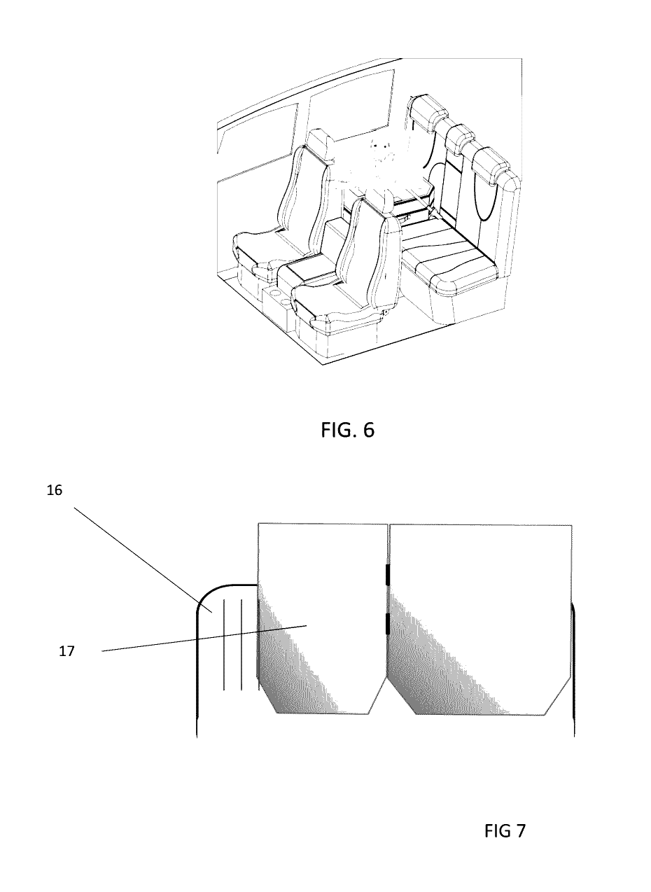

FIG. 6 shows the assembly embodiment in typical use, placed within a representation of a vehicle interior.

FIG. 7 shows a top view of a typical rear passenger seat (16) indicating how different assembly widths of the main horizontal component (1) can be provided to accommodate different sizes of dogs and how an extender (17) may be used to enlarge the riding surface.

### Conclusion, Ramifications, and Scope

Accordingly, the reader will see that the invention:
1. Can be easily installed in any vehicle, without requiring any physical attachment to the interior, where it creates stable, comfortable, elevated riding surfaces for dogs.
2. Accomplishes this by using and connecting various purposefully sized and shaped components made of compressible yet structurally rigid core material and volumetrically filling certain passenger spaces of the vehicles interior.
3. Creates an elevated horizontal surface that spans the entire space from back seat to front seat that allows the dog to rest in a comfortable forward looking position
4. Moves in lock step with the vehicle providing a sense of stability and safety as compared to other loosely tethered devices, covers and assemblies that are easily induced to move oppositely.
5. Enables a riding dog to assume the down resting position while retaining the ability to see out of any window in the vehicle, sharing the visual experience of the ride with the driver and other human passengers.
6. Delivers a more comfortable and safer ride for small, medium and large dogs creating a sense of confidence in the dog.
7. Counteracts most if not all of conditions experienced within a moving vehicle that cause anxiety and motion sickness in dogs.
8. Substantially reduces the danger that the dog rider will be thrown into the legroom area or tossed unpredictably and unsafely throughout the vehicle interior whereas prior art implementations only achieve this by tethering the dog to the vehicle's seat belts or confining it in other ways.

Although the descriptions above contain many specificities, these should not be construed as limiting the scope of the invention but as merely providing illustrations of some of the presently preferred embodiments of this invention. For example, many different safe, comfortable spaces for different purposes may be constructed within a vehicle using the system and methods of the invention.

Thus the scope of the invention should be determined by the appended claims and their legal equivalents, rather than by the examples given.

What is claimed is:

1. An in-vehicle riding and viewing assembly for pets, the assembly comprising:
a component of firm but compressible material that when placed horizontally upon the sitting surface of a passenger seat presents a substantially level top surface, elevated above the original height of the sitting surface of the passenger seat by approximately 4 to 8 inches, spanning substantially all of the distance in the vehicle's lengthwise direction between the upright back portion of the rear passenger seat and the back surface of the opposing front seat and of varying widths;
one or more components of firm but compressible material that are placed in the legroom portion of a human passenger space to provide vertical support to the horizontal platform component and; a plurality of connecting material strips of the hook-and-loop type attached to each component such that the horizontal component and the vertical supporting components can be joined together;
and wherein the assembly achieves an elevated riding and viewing platform in contact with multiple interior surfaces of a vehicle and where direct attachment of any component to any vehicle part is not required to secure the assembly within the vehicle.

2. The Assembly of claim 1 wherein the horizontal component spans substantially all of the distance in the vehicle's lengthwise direction between the surface of the upright portion of the front passenger seat and the opposing dashboard of the vehicle and where the horizontal component spans substantially all of the distance in the direction perpendicular to travel from the passenger side of vehicle center console to the passenger door inner panel.

3. The assembly of claim 1 and claim 2 wherein the core of the horizontal component consists of three layers; a top layer of firm compressible material, a middle layer of thin non-compressible material to act as structural stiffener and a bottom layer of firm compressible material that has a through-hole cutout of sufficient size to fully contain and hold the support components for compact storage and portability of assembly components.

4. The assembly of claim 3 wherein the bottom layer of the horizontal component core is shaped in a manner that is approximately the complement of the contours found typically on the sitting surface of a vehicle passenger seat on which the horizontal component is placed; and further where the horizontal component is mitered on two corners to complement the contours found on the back support surface of a typical vehicle passenger seat.

5. The assembly of claim 4 wherein the components are encased in a zippered covering of nylon or other fabric for easy removal and replacement and further wherein the riding surface of the horizontal component is covered by a tear-away removable fabric top using attaching material of the hook-and-loop type.
